(19) United States
(12) Patent Application Publication
(10) Pub. No.: US 2023/0394535 A1
(43) Pub. Date: Dec. 7, 2023

(54) METHOD AND APPARATUS FOR MAINTAINING A DATABASE

(71) Applicant: Walmart Apollo, LLC, Bentonville, AR (US)

(72) Inventors: Oleksii Zhuk, Milpitas, CA (US); Albert Meltzer, Redwood City, CA (US)

(21) Appl. No.: 18/454,608

(22) Filed: Aug. 23, 2023

Related U.S. Application Data
(63) Continuation of application No. 16/419,223, filed on May 22, 2019.

(51) Int. Cl. G06Q 30/0241; G06Q 30/0242; G06Q 30/0251

(52) U.S. Cl. CPC G06Q 30/0276; G06Q 30/0243; G06Q 30/0271; G06Q 30/0255

(57) ABSTRACT

This application relates to apparatus and methods for maintaining a database. In some examples, a processor receives a request for a first dataset that includes a definition. In response to obtaining the first audience dataset from a database, the processor automatically re-generates the first dataset when a first predetermined time period has elapsed. The first dataset includes a first segment dataset. The processor automatically re-generates the first segment dataset when a second predetermined time period has elapsed. The first segment dataset includes a first dynamic feature dataset. The processor automatically re-generates the first dynamic feature dataset when a third predetermined time period has elapsed. After updating the first dataset (and/or subcomponents thereof), the processor transmits the first dataset to a requesting device.

### CROSS-REFERENCE TO RELATED APPLICATION

This application is a continuation of U.S. patent application Ser. No. 16/419,223, filed May 22, 2019, and entitled “METHOD AND APPARATUS FOR GENERATING DATA DEFINING AN AUDIENCE,” which is incorporated herein by reference in its entirety.

### TECHNICAL FIELD

The disclosure relates generally to data analysis and, more specifically, to maintaining data in a database.

### BACKGROUND

Retailers may benefit from identifying audiences, or groups of customers that share one or more common attributes or traits. For example, retailers may identify an audience to direct more relevant advertisements, such as advertisements displayed when viewing the retailer's web page. Identifying customers that satisfy an audience, however, may involve the manipulation and processing of significant amounts of customer data, which can consume significant amounts of processing time and can be costly. In addition, the accuracy of current audience generation methods can be improved. For example, current systems may result in false-positive identifications, where a customer that is included in an audience should not be included, or can result in false-negatives, where a customer that should be included in the audience is left out. For these and other reasons, there are opportunities to address the identification and generation of data defining an audience.

### SUMMARY

In various embodiments, a system is disclosed. The system includes a database defining a hierarchical structure comprising a plurality of static feature datasets, a plurality of dynamic feature datasets, a plurality of segment datasets each including at least one of a static feature dataset or a dynamic feature dataset, and a plurality of audience datasets each including at least one segment dataset. The system further includes at least one processor configured to modify the database. The at least one processor is configured to receive a request for a first audience dataset. The request includes a definition. When the first audience dataset is included in the plurality of audience datasets stored in the database, obtain the first audience dataset from the database. The processor is further configured to determine, based on a first timestamp indicating when the first audience dataset was updated, when a first predetermined amount of time has elapsed since the first audience dataset was updated and, in response to determining the first predetermined amount of time has elapsed, re-generate and store the first audience dataset in the database. The first audience is re-generated by obtaining the first segment dataset from the database, determining, based on a second timestamp indicating when the first segment was updated, when a second predetermined amount of time has elapsed, and, in response to determining the second predetermined amount of time has elapsed, re-generating the first segment dataset. The first segment dataset is re-generated by obtaining the first dynamic feature dataset from the database, determining, based on a third timestamp indicating when the first dynamic feature dataset was updated, when a third predetermined amount of time has elapsed, and, in response to determining the third predetermined amount of time has elapsed, re-generating the first dynamic feature dataset. The first dynamic feature dataset is re-generated by obtaining server data, processing and formatting the server data to identify at least one dynamic feature and at least one associated user identifier, and storing the first dynamic feature dataset in the database, wherein the first dynamic feature dataset includes the at least one dynamic feature, the at least one associated user identifier, and the third timestamp. A subset of user identifiers is selected from a set of user identifiers associated with the dynamic feature dataset and the first segment dataset is generated including the subset of user identifiers and the second timestamp. The at least one feature value of each of the subset of user identifiers satisfies a first requirement of the definition. The first segment is stored in the set of segments. A final set of user identifiers is identified from the subset of user identifiers associated with the first segment dataset and a subset of user identifiers associated with a second segment dataset. The final set of user identifiers includes user identifiers that are included in each of the subset of user identifiers associated with the first segment and the subset of user identifiers associated with the second segment and for which the at least one feature value of each of the subset of user identifiers satisfies the definition. The first audience dataset is generated including the final set of user identifiers and the first timestamp. In response to generating the first audience dataset, the first audience dataset is stored in the plurality of audience datasets and the first audience dataset is transmitted to a requesting device.

In various embodiments, a computer-implemented method is disclosed. The computer-implemented method includes a step of receiving a request for a first audience dataset. The request includes a definition. When the first audience dataset is included in the plurality of audience datasets stored in the database, the first audience dataset is obtained from the database. The computer-implemented method further includes a step of determining, based on a first timestamp indicating when the first audience dataset was updated, when a first predetermined amount of time has elapsed since the first audience dataset was updated and, in response to determining the first predetermined amount of time has elapsed, re-generating and storing the first audience dataset in the database. The first audience is re-generated by obtaining the first segment dataset from the database, determining, based on a second timestamp indicating when the first segment was updated, when a second predetermined amount of time has elapsed, and, in response to determining the second predetermined amount of time has elapsed, re-generating the first segment dataset. The first segment dataset is re-generated by obtaining the first dynamic feature dataset from the database, determining, based on a third timestamp indicating when the first dynamic feature dataset was updated, when a third predetermined amount of time has elapsed, and, in response to determining the third predetermined amount of time has elapsed, re-generating the first dynamic feature dataset. The first dynamic feature dataset is re-generated by obtaining server data, processing and formatting the server data to identify at least one dynamic feature and at least one associated user identifier, and storing the first dynamic feature dataset in the database, wherein the first dynamic feature dataset includes the at least one dynamic feature, the at least one associated user identifier, and the third timestamp. A subset of user identifiers is selected from a set of user identifiers associated with the dynamic feature dataset and the first segment dataset is generated including the subset of user identifiers and the second timestamp. The at least one feature value of each of the subset of user identifiers satisfies a first requirement of the definition. The first segment is stored in the set of segments. A final set of user identifiers is identified from the subset of user identifiers associated with the first segment dataset and a subset of user identifiers associated with a second segment dataset. The final set of user identifiers includes user identifiers that are included in each of the subset of user identifiers associated with the first segment and the subset of user identifiers associated with the second segment and for which the at least one feature value of each of the subset of user identifiers satisfies the definition. The first audience dataset is generated including the final set of user identifiers and the first timestamp. In response to generating the first audience dataset, the first audience dataset is stored in the plurality of audience datasets and the first audience dataset is transmitted to a requesting device.

In various embodiments, a non-transitory computer readable medium having instructions stored thereon is disclosed. The instructions, when executed by at least one processer, cause a device to perform operations including receiving a request for a first audience dataset. The request includes a definition. When the first audience dataset is included in the plurality of audience datasets stored in the database, the first audience dataset is obtained from the database. The instructions further cause the device to perform operations including determining, based on a first timestamp indicating when the first audience dataset was updated, when a first predetermined amount of time has elapsed since the first audience dataset was updated and, in response to determining the first predetermined amount of time has elapsed, re-generating and storing the first audience dataset in the database. The first audience is re-generated by obtaining the first segment dataset from the database, determining, based on a second timestamp indicating when the first segment was updated, when a second predetermined amount of time has elapsed, and, in response to determining the second predetermined amount of time has elapsed, re-generating the first segment dataset. The first segment dataset is re-generated by obtaining the first dynamic feature dataset from the database, determining, based on a third timestamp indicating when the first dynamic feature dataset was updated, when a third predetermined amount of time has elapsed, and, in response to determining the third predetermined amount of time has elapsed, re-generating the first dynamic feature dataset. The first dynamic feature dataset is re-generated by obtaining server data, processing and formatting the server data to identify at least one dynamic feature and at least one associated user identifier, and storing the first dynamic feature dataset in the database, wherein the first dynamic feature dataset includes the at least one dynamic feature, the at least one associated user identifier, and the third timestamp. A subset of user identifiers is selected from a set of user identifiers associated with the dynamic feature dataset and the first segment dataset is generated including the subset of user identifiers and the second timestamp. The at least one feature value of each of the subset of user identifiers satisfies a first requirement of the definition. The first segment is stored in the set of segments. A final set of user identifiers is identified from the subset of user identifiers associated with the first segment dataset and a subset of user identifiers associated with a second segment dataset. The final set of user identifiers includes user identifiers that are included in each of the subset of user identifiers associated with the first segment and the subset of user identifiers associated with the second segment and for which the at least one feature value of each of the subset of user identifiers satisfies the definition. The first audience dataset is generated including the final set of user identifiers and the first timestamp. In response to generating the first audience dataset, the first audience dataset is stored in the plurality of audience datasets and the first audience dataset is transmitted to a requesting device.

### BRIEF DESCRIPTION OF THE DRAWINGS

The features and advantages of the present disclosures will be more fully disclosed in, or rendered obvious by the following detailed descriptions of example embodiments. The detailed descriptions of the example embodiments are to be considered together with the accompanying drawings wherein like numbers refer to like parts and further wherein:

FIG. 1 is a block diagram of an audience generation system in accordance with some embodiments;

FIG. 2 is a block diagram of the audience generation computing device of FIG. 1 in accordance with some embodiments;

FIG. 3 is a block diagram illustrating examples of various portions of the audience generation system of FIG. 1 in accordance with some embodiments;

FIG. 4 is a block diagram illustrating examples of various portions of the audience generation system of FIG. 1 in accordance with some embodiments;

FIG. 5 is a flowchart of an example method that can be carried out by the audience generation computing device of FIG. 1 in accordance with some embodiments; and

FIG. 6 is a flowchart of another example method that can be carried out by the audience generation computing device of FIG. 1 in accordance with some embodiments.

### DETAILED DESCRIPTION

The description of the preferred embodiments is intended to be read in connection with the accompanying drawings, which are to be considered part of the entire written description of these disclosures. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

It should be understood, however, that the present disclosure is not intended to be limited to the particular forms disclosed. Rather, the present disclosure covers all modifications, equivalents, and alternatives that fall within the spirit and scope of these exemplary embodiments. The terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

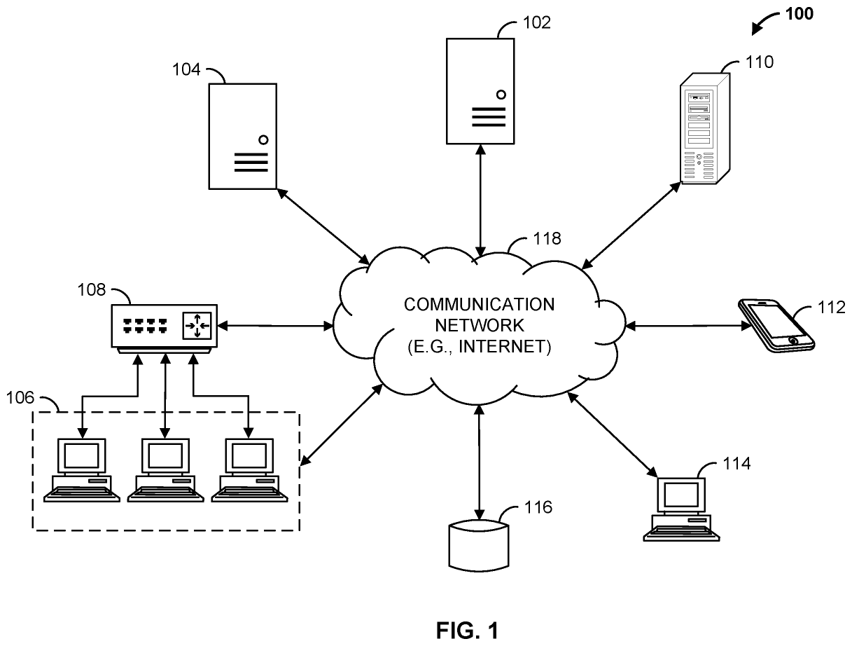

Turning to the drawings, FIG. 1 illustrates a block diagram of an audience generation system 100 that includes an audience generation computing device 102 (e.g., a server, such as an application server), a web hosting device 104 (e.g., a web server), workstation(s) 106, database 116, third-party data server 110, and multiple customer computing devices 112, 114 operatively coupled over network 118. Audience generation computing device 102, web hosting device 104, third-party data server 110, and multiple customer computing devices 112, 114 can each be any suitable computing device that includes any hardware or hardware and software combination for processing and handling information. In addition, each can transmit data to, and receive data from, communication network 118.

For example, each of audience generation computing device 102, web hosting device 104, third-party data server 110, and multiple customer computing devices 112, 114 can be a computer, a workstation, a laptop, a mobile device such as a cellular phone, a web server, an application server, a cloud-based server, or any other suitable device. Each can include, for example, one or more processors, one or more field-programmable gate arrays (FPGAs), one or more application-specific integrated circuits (ASICs), one or more state machines, digital circuitry, or any other suitable circuitry.

Although FIG. 1 illustrates two customer computing devices 112, 114, audience generation system 100 can include any number of customer computing devices 112, 114. Similarly, audience generation system 100 can include any number of workstation(s) 106, audience generation computing devices 102, web servers 104, digital advertisement data servers 110, and databases 116.

Workstation(s) 106 are operably coupled to communication network 118 via router (or switch) 108. For example, workstation(s) 106 can communicate with audience generation computing device 102 over communication network 118. The workstation(s) 106 can allow for the configuration and/or programming of audience generation computing device 102, such as the controlling and/or programming of one or more processors of audience generation computing device 102. Workstation(s) 106 may also communicate with web server 104. For example, web server 104 may host one or more web pages, such as a retailer's website. Workstation(s) 106 may be operable to access and program (e.g., configure) the webpages hosted by web server 104.

Communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. Communication network 118 can provide access to, for example, the Internet.

Audience generation computing device 102, web server 104, and workstation(s) 106 may be operated by a retailer. Customer computing devices 112, 114 may be computing devices operated by customers of a retailer. For example, web server 104 may host one or more web pages for the retailer. Each customer computing device 112, 114 may be operable to access the one or more webpages hosted by web server 104 over communication network 118. For example, a customer operating a customer computing device 112, 114 may view a digital advertisement of a product on a webpage of a retailer's website hosted by web server 104, and purchase the advertised product from the retailer's website.

Third-party data server 110 may provide data related to customers or customer transactions (e.g., purchases). For example, customer data may identify online identifications (IDs) such as webpage cookies, customer account login IDs, credit card numbers, purchase data, purchase timestamps, customer names, customer addresses, customer demographic data, customer geographic data, or customer network addresses (e.g., IP addresses), for example. In some examples, the customer data may identify online advertisement activity such as webpage views or clicks, digital advertisement views or clicks, online purchase history, or in-store purchase history.

Audience generation computing device 102 may be operable to request and receive customer data from third-party data server 110 over communication network 118. For example, third-party data server 110 may provide customer data related to one or more advertisement campaigns that belong to a retailer, where each advertisement campaign is associated with one or more digital advertisement placed on one or more websites. In some examples, third-party data server 110 provides a continuous feed of all customer data records that belong to advertisement campaigns run by the retailer.

Audience generation computing device 102 is also operable to communicate with database 116 over communication network 118. For example, audience generation computing device 102 can store data to, and read data from, database 116. Database 116 may be a tangible, non-transitory memory. For example, database 116 may be a remote storage device, such as a cloud-based server, a memory device on another application server, a networked computer, or any other suitable remote storage. Although shown remote to audience generation computing device 102, in some examples, database 116 can be a local storage device, such as a hard drive, a non-volatile memory, or a USB stick. Database 116 may store data, such as customer data. For example, audience generation computing device 102 may store customer data obtained from third-party data server 110 in database 116. Database 116 may also retail data, such as purchase data related to the purchase history of customers on a retailer's website. Retail data may also include in-store purchase data.

Audience generation computing device 102 may obtain and process customer data to generate static feature data or dynamic feature data. Audience generation computing device 102 may obtain the customer data from either internal sources (e.g., in-store purchases, accounts customers have created with the retailer, online accounts, online purchases made on a retailer's website, etc.), or external sources, such as third-party providers of customer information. Static feature data identifies features that do not typically change, or change at a comparably lower frequency than dynamic segment data. For example, static feature data may include customer identifying information such as customer names, demographic information, geographic information, age, address, or ethnicity. Dynamic segment data includes data that can change more frequently than static feature data, such as data that is based on a given customer's behavior, such as purchasing data (e.g., data identifying previous purchases, or total amounts of previous purchases, in-store or online). In some examples, dynamic segment data may include customer advertisement activity, such as whether an online advertisement was viewed or clicked on by the customer, and whether a purchase resulted from the view or click. Dynamic segment data may also include a customer ranking within a list (e.g., a customer list that ranks customers based on total purchases).

Audience generation computing device 102 may also generate segment definition data identifying and characterizing one or more dynamic segments. A dynamic segment can identify a set of customer IDs (e.g., living unit identifiers (LUIDS)), that share a common feature (e.g., trait). The feature may be, for example, any static feature such as a geographic requirement, a demographic requirement, or any dynamic segment such as a minimum sales amount, a minimum ranking in a customer list, or any retail data requirement, for example.

Audience generation computing device 102 may also generate audience definition data identifying and characterizing one or more audience definitions (e.g., expressions). Each audience definition may be based on a combination of one or more segments, one or more static features, and one or more dynamic segments. Audience generation computing device 102 can generate an audience based on the application of an audience definition to segments, static feature data, and dynamic segment data defined by the audience definition. Each audience definition may identify whether a particular segment or feature is required, or whether a particular segment or feature must not be included. For example, equation 1 below provides an example of an audience definition.

A₁=S₁&(f₁&!f₂) (eq. 1)

In this example, the audience definition requires a customer to be a member of segment S₁, must also have the feature of f₁, and cannot have the feature of f₂ (e.g., “&” represents a logical AND). Only customers meeting these requirements will be identified as members of audience A₁. Equation 2 below shows an example when an audience requires at least one of a set of segments.

A₂=S₁₀&(S₁₃US₄) (eq. 2)

In this example, the audience definition for A₂ requires a customer to be a member of segment S₁₀, and the customer must also be a member of either S₁₃ or S₄ (or both, e.g., U represents a logical OR) to be identified as a member of audience A₂.

Audience generation computing device 102 may determine whether to regenerate an audience based on whether the audience is based on static features and/or dynamic segments. For example, if the audience requires a dynamic segment that does not yet exist, audience generation computing device 102 generates the new segment and stores it to database 116. Otherwise, if all dynamic segments have been previously generated, audience generation computing device 102 determines whether a maximum amount of time has elapsed since any required dynamic segment was previously generated. If the maximum amount of time has not yet elapsed, audience generation computing device 102 uses the dynamic segments to generate any audience requiring those dynamic segments. If the maximum amount of time has elapsed, audience generation computing device 102 regenerates the dynamic segment before generating any audience requiring that segment.

For example, assume a first audience is based on a first static feature that requires a particular demographic, a second static feature that requires a home address of a particular state, and a third static feature that requires the home address to be in a particular city. Assume a second audience is based on a first dynamic segment that requires a minimum purchase amount of a particular product and a second dynamic segment that requires a number of webpage views of a particular webpage over a period of time (e.g., 30 days, the last month, etc.). Audience generation computing device 102 may rebuild the first dynamic segment daily, for example, but may build the first, second, and third static features once per month. In this example, audience generation computing device 102 may rebuild the second audience more often than it builds the first audience, because the first audience is based on static features that change less often than dynamic segments. In this manner, audience generation computing device 102 may minimize how often any particular audience is built.

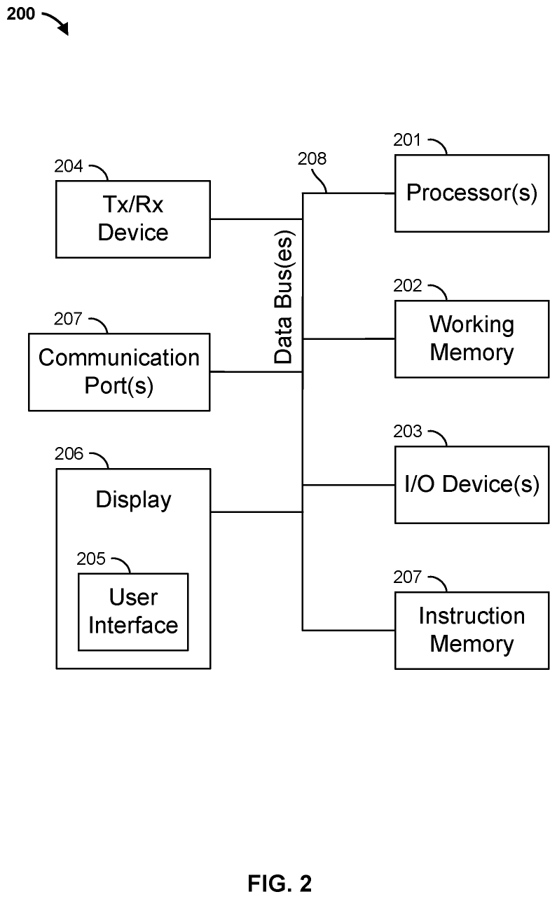

FIG. 2 illustrates the audience generation computing device 102 of FIG. 1. Audience generation computing device 102 can include one or more processors 201, working memory 202, one or more input/output devices 203, instruction memory 207, a transceiver 204, one or more communication ports 207, and a display 206, all operatively coupled to one or more data buses 208. Data buses 208 allow for communication among the various devices. Data buses 208 can include wired, or wireless, communication channels.

Processors 201 can include one or more distinct processors, each having one or more cores. Each of the distinct processors can have the same or different structure. Processors 201 can include one or more central processing units (CPUs), one or more graphics processing units (GPUs), application specific integrated circuits (ASICs), digital signal processors (DSPs), and the like.

Processors 201 can be configured to perform a certain function or operation by executing code, stored on instruction memory 207, embodying the function or operation. For example, processors 201 can be configured to perform one or more of any function, method, or operation disclosed herein.

Instruction memory 207 can store instructions that can be accessed (e.g., read) and executed by processors 201. For example, instruction memory 207 can be a non-transitory, computer-readable storage medium such as a read-only memory (ROM), an electrically erasable programmable read-only memory (EEPROM), flash memory, a removable disk, CD-ROM, any non-volatile memory, or any other suitable memory.

Processors 201 can store data to, and read data from, working memory 202. For example, processors 201 can store a working set of instructions to working memory 202, such as instructions loaded from instruction memory 207. Processors 201 can also use working memory 202 to store dynamic data created during the operation of audience generation computing device 102. Working memory 202 can be a random access memory (RAM) such as a static random access memory (SRAM) or dynamic random access memory (DRAM), or any other suitable memory.

Input-output devices 203 can include any suitable device that allows for data input or output. For example, input-output devices 203 can include one or more of a keyboard, a touchpad, a mouse, a stylus, a touchscreen, a physical button, a speaker, a microphone, or any other suitable input or output device.

Communication port(s) 207 can include, for example, a serial port such as a universal asynchronous receiver/transmitter (UART) connection, a Universal Serial Bus (USB) connection, or any other suitable communication port or connection. In some examples, communication port(s) 207 allows for the programming of executable instructions in instruction memory 207. In some examples, communication port(s) 207 allow for the transfer (e.g., uploading or downloading) of data, such as customer data, feature data, or segment data.

Display 206 can display user interface 205. User interfaces 205 can enable user interaction with audience generation computing device 102. For example, user interface 205 can be a user interface for an application that allows for the viewing of semantic representations of user queries. In some examples, a user can interact with user interface 205 by engaging input-output devices 203. In some examples, display 206 can be a touchscreen, where user interface 205 is displayed on the touchscreen.

Transceiver 204 allows for communication with a network, such as the communication network 118 of FIG. 1. For example, if communication network 118 of FIG. 1 is a cellular network, transceiver 204 is configured to allow communications with the cellular network. In some examples, transceiver 204 is selected based on the type of communication network 118 audience generation computing device 102 will be operating in. Processor(s) 201 is operable to receive data from, or send data to, a network, such as communication network 118 of FIG. 1, via transceiver 204.

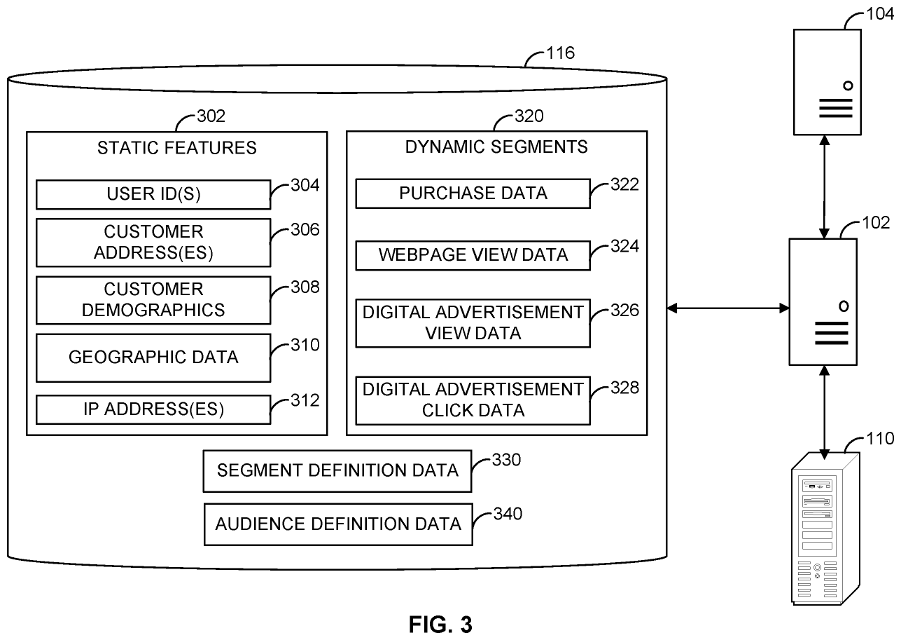

FIG. 3 is a block diagram illustrating various portions of the audience generation system 100 of FIG. 1. As indicated in the figure, database 116 includes static features 302 and dynamic segments 320. For example, audience generation computing device 102 may receive customer data from third-party server 110, and store the customer data as static features 302 and dynamic segments 320. Audience generation computing device 102 may also store customer data related to previous purchases as static features 302 (e.g., a customer name) and dynamic segments 320 (e.g., purchase dates and items purchased), such as customer data received from web server 104 when a customer proceeds with a purchase from a hosted website. Static features 302 and dynamic segments 320 may identify a user (e.g., via a user ID), and a corresponding static or dynamic attribute.

In this example static features 302 includes user IDs 304, customer addresses 306, customer demographics 308 (e.g., ethnicity of each customer), geographic data 310 (e.g., country, state, or city of each customer), and IP addresses 312 (e.g., IP address of a networked computing device each customer may have visited a retailer's website from). Dynamic segments 320 includes purchase data 322, which may identify data related to previous orders from each customer. Dynamic segments 320 also includes webpage view data 324, which may identify timestamps associated with views of a retailer's webpage. Dynamic segments 320 further includes digital advertisement view data 326 and digital advertisement click data 328. Digital advertisement view data 326 may identify timestamps related to when a customer viewed a digital advertisement, such as on a retailer's website, and digital advertisement click data 328 identifies timestamps associated with when the customer clicked on the digital advertisement. Static features 302 and dynamic segments 320 may each include additional static and dynamic segments, respectively.

Database 116 may also store segment definition data 330, which identifies and characterizes one or more dynamic segments. For example, segment definition data 330 may include an identification of each dynamic segment (e.g., S₁, S₂, etc.), a requirement for each dynamic segment (e.g., a demographic or geographic requirement), as well as a list of user IDs that correspond to each segment. As noted above, each dynamic segment may include one or more customer IDs identifying customers that meet the requirement for the corresponding segment. Database 116 may also store audience definition data 340, which identifies one or more audience definitions. Audience generation computing device 102 can generate an audience based on executing an audience definition identified by audience definition data 340.

Audience generation computing device 102 may determine whether a segment identified by segment definition data 330 requires updating based on whether the segment is based on static features 302 or dynamic segments 320. If the segment is based on dynamic segments 320, audience generation computing device 102 may periodically regenerate the segment. For example, audience generation computing device 102 may generate the segment daily or weekly. If, however, the segment is based on static features 302, audience generation computing device 102 may regenerate the segment less frequently. For example, audience generation computing device 102 may regenerate the segment monthly or every three months.

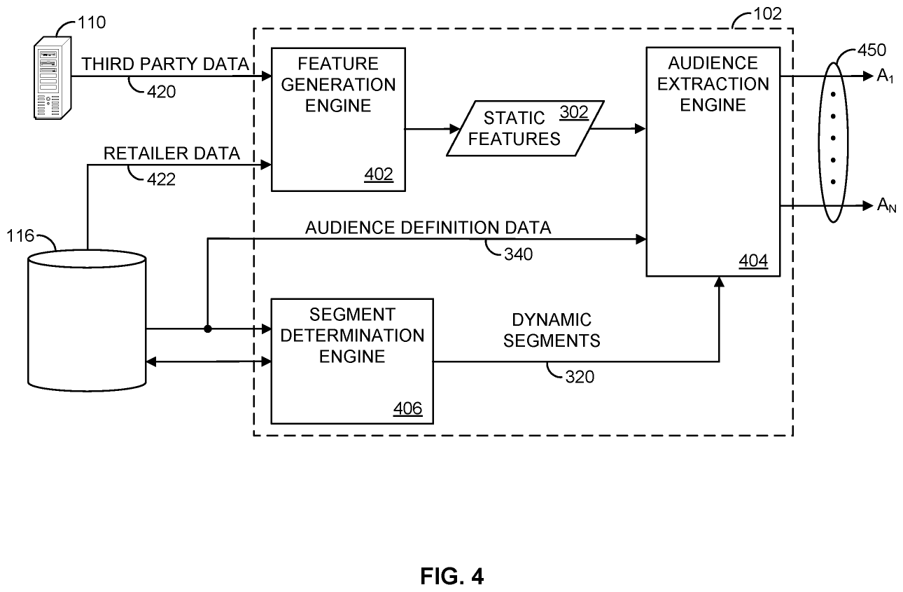

FIG. 4 illustrates various portions of the audience generation system 100 of FIG. 1. As indicated in the figure, audience generation computing device 102 includes feature generation engine 402, segment determination engine 406, and audience extraction engine 404. In some examples, one or more of feature generation engine 402, segment determination engine 406, and audience extraction engine 404 may be implemented in hardware. In some examples, one or more of feature generation engine 402, segment determination engine 406, and audience extraction engine 404 may be implemented as an executable program maintained in a tangible, non-transitory memory, such as instruction memory 207 of FIG. 2, that may be executed by one or processors, such as processor 201 of FIG. 2.

Feature generation engine 402 can receive third party data 420 from third-party server 110, which may include consumer data. Third party data 420 may identify a user (via, e.g., a user ID), and a corresponding static or dynamic attribute (e.g., address, demographic, purchase related data, etc.). Feature generation engine 402 may also obtain retailer data 422 from database 116. Retailer data 422 may identify a user and related consumer data or purchase data related to consumer purchase histories maintained by a retailer. Retailer data 422 may include, for example, consumer data obtained by audience generation computing device 102 from web server 104 and stored in database 116. Feature generation engine 402 may process and format third party data 420 and retailer data 422 to provide static features 302. In some examples, feature generation engine 402 stores static features 302 in database 116.

Segment determination engine 406 may obtain audience definition data 340, which identifies one or more audience definitions, and determine which static features 302 or dynamic segments 320 are required by each audience definition. For example, for the audience definition A₁ of equation 1 above, segment determination engine can determine that dynamic segment S₁ is required. Similarly, segment determination engine can determine that static features f₁ and f₂ are required. For the audience definition A₂ of equation 2 above, segment determination engine 406 can determine that dynamic segments S₁₀, S₁₃, and S₄ are required. Segment determination engine 406 can provide dynamic segments 320 to audience extraction engine 404, which identifies the required segments. For example, segment determination engine 406 can obtain the required dynamic segments from database 116 as identified by segment definition data 330.

In some examples, segment determination engine 406, before providing dynamic segments 320, determines whether a maximum amount of time has elapsed since each of the required segments were previously generated. For example, segment definition data 330 may include a timestamp indicating the last time the segment was generated. Segment determination engine 406 may compare a current timestamp to the timestamp indicated by segment definition data 330 to determine the amount of time elapsed since the segment was generated. If any of the required segments were not previously generated within the maximum amount of time, segment determination engine 406 regenerates the segment, and stores the updated segment as segment definition data 330 in database 116. Segment determination engine 406 then provides the updated segments via dynamic segments 320. In some examples, segment determination engine 406 regenerates segments that are based on static data less often than segments that are based on dynamic data. For example, the maximum amount of time before regeneration for a segment based on dynamic data (e.g., hourly) may be less than the maximum amount of time before regeneration for a segment based on static data (e.g., monthly).

Audience extraction engine 404 can provide one or more audiences 450 based on audience definitions 340. For example, audience extraction engine 404 may obtain audience definition data 340 to determine the definition for one or more audiences. Audience extraction engine 404 may determine, for each audience definition 340, any required static features 302 and dynamic segments 320. Audience extraction engine 404 applies the audience definition 340 to the required static features 302 and dynamic segments 320 to determine each audience. For example, assume that audience definition data 340 identifies the audience definition of equation 1 above, which is reproduced here.

A₁=S₁&(f₁&!f₂) (eq. 1)

Audience extraction engine 404 may obtain dynamic segment S₁ from dynamic segments 320. In addition, audience extraction engine 404 may obtain static feature f₁ and static feature f₂ from static features 302. Audience extraction engine 404 may then apply the audience definition to dynamic segment S₁ and static features f₁ and f₂ to determine an audience 450. In this example, audience extraction engine 404 determines users (e.g., user IDs) that are associated with (e.g., belong to) segment S₁ and are associated with (e.g., satisfy the requirement of) static feature f₁ but not static feature f₂. The users satisfying these three requirements (i.e., S₁, f₁, !f₂) comprise the generated audience.

In some examples, audience extraction engine 404 provides an audience 450 in response to an audience request. For example, audience generation computing device 102 may receive a request for a particular audience. In response, audience generation computing device 102 may obtain the audience definition 340 for the requested audience from database 116, and generate the requested audience. In some examples, audience generation computing device 102 stores generated audiences in database 116. If a request for an audience is received, audience generation computing device 102 first determines whether a maximum amount of time has passed since the audience was last generated. The maximum amount of time may differ for various audience definitions based on whether an audience definition includes dynamic segments. For example, if an audience definition does not include dynamic segments, the maximum amount of time may be a week, a month, or some other period of time. If, however, the audience definition does include a dynamic segment, the maximum amount of time may be relatively shorter. For example, the maximum amount of time may be 15 minutes, an hour, or a day. If the maximum amount of time for the requested audience has not elapsed since the audience was last generated, audience generation computing device 102 provides the audience as last generated. Otherwise, if the maximum amount of time for the requested audience has elapsed, audience generation computing device 102 regenerates the audience and provides the updated audience in response to the audience request.

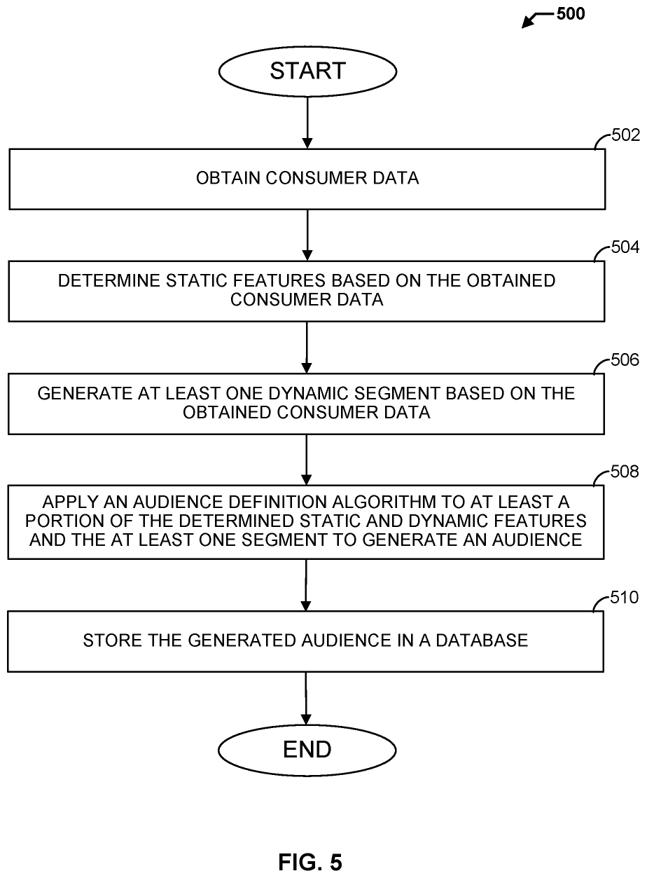

FIG. 5 is a flowchart of an example method 500 that can be carried out by, for example, the audience generation computing device 102 of FIG. 1. Beginning at step 502, consumer data is obtained. The consumer data may be third party data 420 and retailer data 422, for example. At step 504, static features are determined based on the obtained consumer data. For example, audience generation computing device 102 may generate static features 302 based on third party data 420 and retailer data 422.

Proceeding to step 506, at least one dynamic segment is generated based on the obtained consumer data. For example, segment determination engine 406 of audience generation computing device 102 may generate a dynamic segment if a maximum amount of time has elapsed since the segment was last generated. At step 508, an audience definition algorithm is applied to at least a portion of the static and dynamic segments and any generated segments. For example, audience extraction engine 404 of audience generation computing device 102 may determine required static and dynamic segments and segments to generate an audience identified by audience definition data 340. Audience extraction engine 404 may then generate the audience based on the required static and dynamic segments and segments. The method then ends.

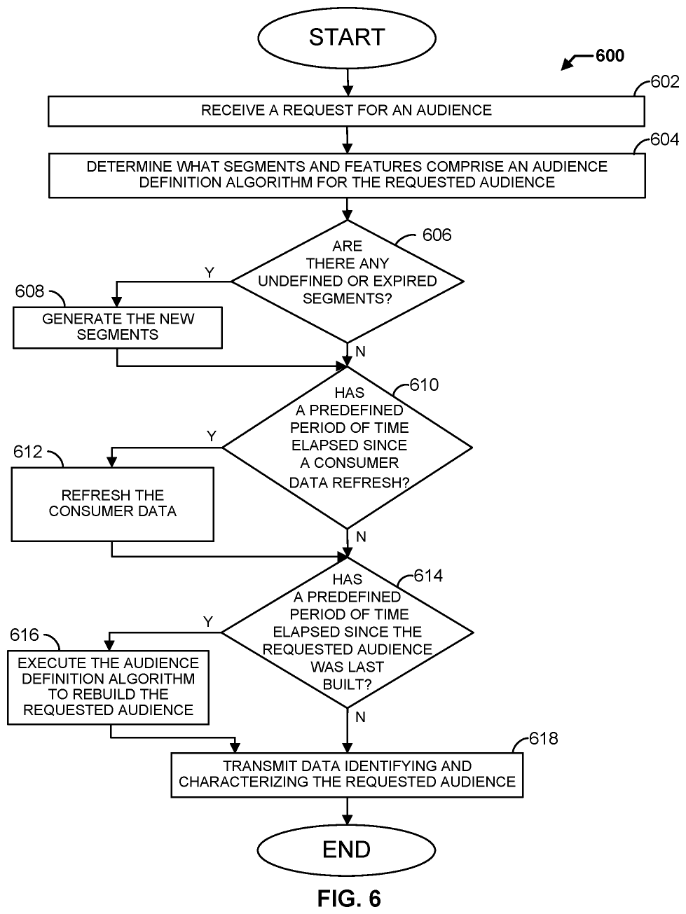

FIG. 6 is a flowchart of another example method 600 that can be carried out by, for example, the audience generation computing device 102 of FIG. 1. Beginning at step 602, a request for an audience is received. For example, audience generation computing device 102 may receive a request for a particular audience. At step 604, segments and features required for the request audience is determined for an audience definition algorithm of the requested audience. For example, audience generation computing device 102 may obtain from database 116 audience definition data 340 for the requested audience. At step 606, a determination is made as to whether the audience definition algorithm includes any undefined or expired dynamic segments. An undefined segment may be, for example, a segment that has not yet been generated. An expired dynamic segment may be one that is valid up to a particular date, where that date has passed, for example. If the audience definition algorithm includes any undefined or undefined segments, the method proceeds to step 608, where the new segments are generated. The method proceeds to step 610 from step 608, or from step 606 if all segments for the audience definition algorithm are defined (e.g., generated).

At step 610, a determination is made as to whether a predefined period of time has elapsed since a previous feature data refresh was executed. A feature data refresh may be, for example, a request for third party data 420 and/or retailer data 422. If the predefined period of time has elapsed since the last feature data refresh was executed, the method proceeds to step 612, where the consumer data is refreshed. For example, audience generation computing device 102 may request and obtain third party data 420 and retailer data 422. The method proceeds to step 614 from step 612, or from step 610 if the predefined period of time has not elapsed since the last feature data refresh was executed.

At step 614, a determination is made as to whether a predefined period of time has elapsed since the requested audience was last built (e.g., generated). If the predefined period of time has elapsed since the requested audience was last built, the method proceeds to step 616. At step 616, the audience definition algorithm for the audience is executed to rebuild the requested audience. The method then proceeds to step 618. Otherwise, if at step 614 the predefine period of time has not elapsed, the method proceeds to step 618. At step 618, data identifying and characterizing the requested audience is transmitted. If the audience was regenerated at step 616, the updated audience is transmitted. Otherwise, the audience as previously generated is transmitted. For example, audience generation computing device 102 may transmit an audience 450 to another computing device. The method then ends.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. A system, comprising:
a database defining a hierarchical structure comprising a plurality of static feature datasets, a plurality of dynamic feature datasets, a plurality of segment datasets each including at least one of a static feature dataset or a dynamic feature dataset, and a plurality of audience datasets each including at least one segment dataset; and
at least one processor configured to modify the database, wherein the at least one processor is configured to:
receive a request for a first audience dataset, wherein the request includes a definition;
when the first audience dataset is included in the plurality of audience datasets stored in the database, obtain the first audience dataset from the database;
determine, based on a first timestamp indicating when the first audience dataset was updated, when a first predetermined amount of time has elapsed since the first audience dataset was updated; and
in response to determining the first predetermined amount of time has elapsed, re-generate and store the first audience dataset in the database, wherein the first audience is re-generated by:
obtaining the first segment dataset from the database; and
determining, based on a second timestamp indicating when the first segment was updated, when a second predetermined amount of time has elapsed;
in response to determining the second predetermined amount of time has elapsed, re-generating the first segment dataset, wherein the first segment dataset is re-generated by:
obtaining the first dynamic feature dataset from the database; and
determining, based on a third timestamp indicating when the first dynamic feature dataset was updated, when a third predetermined amount of time has elapsed;
in response to determining the third predetermined amount of time has elapsed, re-generating the first dynamic feature dataset, wherein the first dynamic feature dataset is re-generated by:
obtaining server data;
processing and formatting the server data to identify at least one dynamic feature and at least one associated user identifier; and
storing the first dynamic feature dataset in the database, wherein the first dynamic feature dataset includes the at least one dynamic feature, the at least one associated user identifier, and the third timestamp;
selecting a subset of user identifiers from a set of user identifiers associated with the dynamic feature dataset, wherein the at least one feature value of each of the subset of user identifiers satisfies a first requirement of the definition;
generating the first segment dataset including the subset of user identifiers and the second timestamp; and
storing the first segment in the set of segments;
identifying a final set of user identifiers from the subset of user identifiers associated with the first segment dataset and a subset of user identifiers associated with a second segment dataset, wherein the final set of user identifiers includes user identifiers that are included in each of the subset of user identifiers associated with the first segment and the subset of user identifiers associated with the second segment and for which the at least one feature value of each of the subset of user identifiers satisfies the definition;
generating the first audience dataset including the final set of user identifiers and the first timestamp; and
in response to generating the first audience dataset, storing the first audience dataset in the plurality of audience datasets; and
transmit the first audience dataset to a requesting device.

2. The system of claim 1, wherein the processor is further configured to:
determine when the second segment is included in the set of segments, wherein the second segment comprises at least one identifier identifying a first static feature in the set of static features, a second requirement for the first static feature, a set of user identifiers corresponding to the second requirement, and a fourth timestamp identifying when the second segment was updated;
obtain the second segment from the database;
determine, based on the fourth timestamp, when a fourth predetermined amount of time has elapsed; and
in response to determining more than the fourth predetermined amount of time has elapsed, re-generate the second segment, wherein the second segment is re-generated by:
determining when the first static feature is included in the set of static features, the first static feature including a set of user identifiers each having at least one static feature value associated therewith and a fifth timestamp identifying when the first static feature was built or updated, wherein the at least one static feature value corresponds to the second requirement;
in response to determining the first static feature is included in the set of static features, obtaining the first static feature from the database;
determining, based on the fifth timestamp, when a fifth predetermined amount of time has elapsed;
in response to determining the more than the fifth predetermined amount of time has elapsed, re-generating the first static feature;
selecting a subset of user identifiers from the set of user identifiers associated with the first static feature, wherein the at least one static feature value of each of the subset of user identifiers satisfies the second requirement;
generating the second segment including the subset of the set of user identifiers identifying the first static feature in the set of static features and the fifth timestamp; and
storing the second segment in the set of segments.

3. The system of claim 1, wherein the processor is configured to:
obtain a second audience definition for a second audience;
determine a third segment required by the second audience definition;
determine that the third segment was previously generated and stored in the set of segments; and
without generating the third segment, generate the second audience based on the second audience definition.

4. The system of claim 1, wherein the processor is configured to:
obtain a second audience definition for a second audience;
determine the second audience definition requires the first segment;
retrieve the first segment from the database; and
generate the second audience based on the second audience definition.

5. The system of claim 1, wherein the processor is configured to:
generate a plurality of static features based on the third party data and the retailer data; and
determine the first audience definition requires a static feature from the plurality of static features.

6. The system of claim 5, wherein generating the plurality of static features comprises determining that an amount of time has elapsed since the plurality of static features were last generated.

7. The system of claim 1, wherein the first predetermined amount of time is greater than the second predetermined amount of time and the second predetermined amount of time is greater than the third predetermined amount of time.

8. A computer-implemented method, comprising:
receiving a request for a first audience dataset, wherein the request includes a definition;
when the first audience dataset is included in a plurality of audience datasets stored in a database, obtaining the first audience dataset from the database; and
determining, based on a first timestamp indicating when the first audience dataset was updated, when a first predetermined amount of time has elapsed since the first audience dataset was updated;
in response to determining the first predetermined amount of time has elapsed, re-generating and storing the first audience dataset in the database, wherein the first audience is re-generated by:
obtaining the first segment dataset from the database; and
determining, based on a second timestamp indicating when the first segment was updated, when a second predetermined amount of time has elapsed;
in response to determining the second predetermined amount of time has elapsed, re-generating the first segment dataset, wherein the first segment dataset is re-generated by:
obtaining the first dynamic feature dataset from the database; and
determining, based on a third timestamp indicating when the first dynamic feature dataset was updated, when a third predetermined amount of time has elapsed;
in response to determining the third predetermined amount of time has elapsed, re-generating the first dynamic feature dataset, wherein the first dynamic feature dataset is re-generated by:
obtaining server data;
processing and formatting the server data to identify at least one dynamic feature and at least one associated user identifier; and
storing the first dynamic feature dataset in the database, wherein the first dynamic feature dataset includes the at least one dynamic feature, the at least one associated user identifier, and the third timestamp; and
selecting a subset of user identifiers from a set of user identifiers associated with the dynamic feature dataset, wherein the at least one feature value of each of the subset of user identifiers satisfies a first requirement of the definition;
re-generating the first segment dataset including the subset of user identifiers and the second timestamp; and
storing the first segment in the set of segments;
identifying a final set of user identifiers from the subset of user identifiers associated with the first segment dataset and a subset of user identifiers associated with a second segment dataset, wherein the final set of user identifiers includes user identifiers that are included in each of the subset of user identifiers associated with the first segment and the subset of user identifiers associated with the second segment and for which the at least one feature value of each of the subset of user identifiers satisfies the definition;
generating the first audience dataset including the final set of user identifiers and the first timestamp;
in response to generating the first audience dataset, storing the first audience dataset in the plurality of audience datasets; and
transmitting the first audience dataset to a requesting device.

9. The computer-implemented method of claim 8, comprising:
determining when the second segment is included in the set of segments, wherein the second segment comprises at least one identifier identifying a first static feature in the set of static features, a second requirement for the first static feature, a set of user identifiers corresponding to the second requirement, and a fourth timestamp identifying when the second segment was built or updated;
in response to determining the second segment is included in the set of segments:
obtaining the second segment from the database; and
determining, based on the fourth timestamp, when a fourth predetermined amount of time has elapsed;
in response to determining the second segment is not included in the set of segments or more than the fourth predetermined amount of time has elapsed, generating the second segment, wherein the second segment is generated by:
determining when the first static feature is included in the set of static features, the first static feature including a set of user identifiers each having at least one static feature value associated therewith and a fifth timestamp identifying when the first static feature was built or updated, wherein the at least one static feature value corresponds to the second requirement;
in response to determining the first static feature is included in the set of static features:
obtaining the first static feature from the database; and
determining, based on the fifth timestamp, when a fifth predetermined amount of time has elapsed;
in response to determining the first static feature is not included in the set of static features or more than the fifth predetermined amount of time has elapsed, generating the first static feature;
selecting a subset of user identifiers from the set of user identifiers associated with the first static feature, wherein the at least one static feature value of each of the subset of user identifiers satisfies the second requirement;
generating the second segment including the subset of the set of user identifiers identifying the first static feature in the set of static features and the fifth timestamp; and
storing the second segment in the set of segments.

10. The computer-implemented method of claim 8, comprising:
obtaining a second audience definition for a second audience;
determining a third segment required by the second audience definition;
determining that the third segment was previously generated and stored in the set of segments; and
without generating the third segment, generating the second audience based on the second audience definition.

11. The computer-implemented method of claim 8, comprising:
obtaining a second audience definition for a second audience;
determining the second audience definition requires the first segment;
retrieving the first segment from the database; and
generating the second audience based on the second audience definition.

12. The computer-implemented method of claim 8, comprising:
generating a plurality of static features based on the third party data and the retailer data; and
determining the first audience definition requires a static feature from the plurality of static features.

13. The computer-implemented method of claim 12, wherein generating the plurality of static features comprises determining that an amount of time has elapsed since the plurality of static features were last generated.

14. The computer-implemented method of claim 8, wherein the first predetermined amount of time is greater than the second predetermined amount of time and the second predetermined amount of time is greater than the third predetermined amount of time.

15. A non-transitory computer readable medium having instructions stored thereon that, when executed by one or more processors, cause a device to perform operations comprising:
receiving a request for a first audience dataset, wherein the request includes a definition;
when the first audience dataset is included in a plurality of audience datasets stored in a database, obtaining the first audience dataset from the database; and
determining, based on a first timestamp indicating when the first audience dataset was updated, when a first predetermined amount of time has elapsed since the first audience dataset was updated;
in response to determining the first predetermined amount of time has elapsed, re-generating and storing the first audience dataset in the database, wherein the first audience is re-generated by:
obtaining the first segment dataset from the database; and
determining, based on a second timestamp indicating when the first segment was updated, when a second predetermined amount of time has elapsed;
in response to determining the second predetermined amount of time has elapsed, re-generating the first segment dataset, wherein the first segment dataset is re-generated by:
obtaining the first dynamic feature dataset from the database; and
determining, based on a third timestamp indicating when the first dynamic feature dataset was updated, when a third predetermined amount of time has elapsed;
in response to determining the third predetermined amount of time has elapsed, re-generating the first dynamic feature dataset, wherein the first dynamic feature dataset is re-generated by:
obtaining server data;
processing and formatting the server data to identify at least one dynamic feature and at least one associated user identifier; and
storing the first dynamic feature dataset in the database, wherein the first dynamic feature dataset includes the at least one dynamic feature, the at least one associated user identifier, and the third timestamp; and
selecting a subset of user identifiers from a set of user identifiers associated with the dynamic feature dataset, wherein the at least one feature value of each of the subset of user identifiers satisfies a first requirement of the definition;
re-generating the first segment dataset including the subset of user identifiers and the second timestamp; and
storing the first segment in the set of segments;
identifying a final set of user identifiers from the subset of user identifiers associated with the first segment dataset and a subset of user identifiers associated with a second segment dataset, wherein the final set of user identifiers includes user identifiers that are included in each of the subset of user identifiers associated with the first segment and the subset of user identifiers associated with the second segment and for which the at least one feature value of each of the subset of user identifiers satisfies the definition;
generating the first audience dataset including the final set of user identifiers and the first timestamp;
in response to generating the first audience dataset, storing the first audience dataset in the plurality of audience datasets; and
transmitting the first audience dataset to a requesting device.

16. The non-transitory computer readable medium of claim 15, wherein the instructions, when executed by the processor, cause the device to perform operations comprising:
determining when the second segment is included in the set of segments, wherein the second segment comprises at least one identifier identifying a first static feature in the set of static features, a second requirement for the first static feature, a set of user identifiers corresponding to the second requirement, and a fourth timestamp identifying when the second segment was built or updated;
in response to determining the second segment is included in the set of segments:
obtaining the second segment from the database; and
determining, based on the fourth timestamp, when a fourth predetermined amount of time has elapsed;
in response to determining the second segment is not included in the set of segments or more than the fourth predetermined amount of time has elapsed, generating the second segment, wherein the second segment is generated by:
determining when the first static feature is included in the set of static features, the first static feature including a set of user identifiers each having at least one static feature value associated therewith and a fifth timestamp identifying when the first static feature was built or updated, wherein the at least one static feature value corresponds to the second requirement;
in response to determining the first static feature is included in the set of static features:
obtaining the first static feature from the database; and
determining, based on the fifth timestamp, when a fifth predetermined amount of time has elapsed;
in response to determining the first static feature is not included in the set of static features or more than the fifth predetermined amount of time has elapsed, generating the first static feature;
selecting a subset of user identifiers from the set of user identifiers associated with the first static feature, wherein the at least one static feature value of each of the subset of user identifiers satisfies the second requirement;
generating the second segment including the subset of the set of user identifiers identifying the first static feature in the set of static features and the fifth timestamp; and
storing the second segment in the set of segments.

17. The non-transitory computer readable medium of claim 15, wherein the instructions, when executed by the processor, cause the device to perform operations comprising:
obtaining a second audience definition for a second audience;
determining a third segment required by the second audience definition;
determining that the third segment was previously generated and stored in the set of segments; and
without generating the third segment, generating the second audience based on the second audience definition.

18. The non-transitory computer readable medium of claim 15, wherein the instructions, when executed by the processor, cause the device to perform operations comprising:
obtaining a second audience definition for a second audience;
determining the second audience definition requires the first segment;
retrieving the first segment from the database; and
generating the second audience based on the second audience definition.

19. The non-transitory computer readable medium of claim 15, wherein the instructions, when executed by the processor, cause the device to perform operations comprising:
generating a plurality of static features based on the third party data and the retailer data; and
determining the first audience definition requires a static feature from the plurality of static features.

20. The non-transitory computer readable medium of claim 19, wherein the instructions, when executed by the processor, cause the device to perform operations comprising, wherein generating the plurality of static features comprises determining that an amount of time has elapsed since the plurality of static features were last generated.
